(19) United States
(12) Patent Application Publication
(10) Pub. No.: US 2016/0368649 A1
(43) Pub. Date: Dec. 22, 2016

(54) Opaque Container

(71) Applicant: The Procter & Gamble Company, Cincinnati, OH (US)

(72) Inventors: Shannon Beth ESCHENBURG, Maineville, OH (US); Bradley Scott NEUFARTH, Loveland, OH (US); Shuo SONG, Beijing (CN); Ping WANG, Beijing (CN); Liang YANG, Beijing (CN); Gaoyang WANG, Dongguan (CN)

(21) Appl. No.: 15/186,849

(22) Filed: Jun. 20, 2016

(30) Foreign Application Priority Data
Jun. 19, 2015 (WO) CN2015/081896

(51) Int. Cl. B65D 1/02; B29C 49/00

(52) U.S. Cl. CPC B65D 1/0215; B29C 49/0005; B29C 2049/001; B29K 2023/12

(57) ABSTRACT

An opaque blow molded article, comprising a first thermoplastic material, a second thermoplastic material and an additive selected from the group consisting of an alcohol, oil, siloxane fluid, water, and a combination thereof. The first thermoplastic material and said second thermoplastic material have a solubility parameter difference from about 0.1 cal^{1/2}cm^{-3/2} to about 20 Cal^{1/2}cm^{-3/2}, and a refractive index difference from about 0.1 to about 1.5.

### TECHNICAL FIELD

The present invention relates to an opaque blow molded article, and a process for making the article.

### BACKGROUND

Containers made of thermoplastic materials have been used to package a wide variety of consumer products such as cosmetics, shampoo, laundry, and food. For such containers, having a glossy appearance is particularly appealing to users. A glossy, pearl-like luster or metallic luster effect, traditionally provided by the addition of pearlescent agents, tends to connote a premium product. For products that are not so visually appealing to consumers, for example, shampoos, conditioners and laundry detergents, it is sometimes also desirable for the container to be opaque.

Traditionally, opacity is obtained in a container formed of thermoplastic materials by dispersing coloured pigments, such as titanium dioxide or white pigments, into a polymer matrix. Coloured pigments provide opacity by absorbing and/or scattering visible light (400 nm-700 nm). Most pigments used in manufacturing of, for example, rigid containers, are dry colourants that are usually ground into a fine powder before incorporation in another base material (e.g., a polymer). To create an opaque container, pigments may come in different forms, such as white oxide powders which scatter light, or dark coloured powders that absorb and scatter light. Adding these pigments to a thermoplastic substrate renders the final article opaque, regardless of whether the original substrate was clear or opaque. Other methods to form opaque containers include chromatic ink layers formed with a light blocking printed layer (U.S. Pat. No. 7,560,150 B2).

Titanium dioxide (TiO₂) is a multifaceted material when used in polymer applications and has long been established as a leading white pigment. However, there are a number of issues associated with TiO2 when incorporated into packaging for opacity reasons. For example, inclusion of TiO₂ may compromise the glossiness of an article as the size of the TiO₂ particles damage the smoothness of the exterior of the packaging, which in turn negatively impacts light interference. Furthermore, TiO₂ can affect manufacturability if included in an article being manufactured via, for example, injection stretch blow molding. ISBM requires a two-step process that involves making a pre-form, then allowing it to cool down over a couple of days and re-heating it to make the final article. The process of re-heating is done using infra-red light at about 80 degrees. However TiO₂ has a high refractive index (approximately 2.7), which makes it difficult to re-heat, requiring a special process to re-heat the pre-form.

Another way to achieve opacity in a plastic container is by blending together different plastic materials, such as polyethylene terephthalate (PET) and polypropylene (PP). The paper

“Barrier, Adsorptive, and Mechanical Properties of Containers Molded from PET/PP Blends for User in Pharmaceutical Solutions” by Tadashi Otsuka et al (Materials Sciences and Applications, 2013, 4, 589-594) discusses use of a blend of PET and PP. From this it can be seen that inclusion of 100% of either PET or PP produces a transparent container, whereas any degree of blend (e.g., from 1:9 to 9:1 of PET:PP) produces a translucent or opaque container. As can be seen from FIG. 11 of the paper by Otsuka et al. (reproduced as FIG. 1 herein) these opaque containers have a matt, rather than a glossy, finish.

Therefore, there is still a need for the development of an opaque container that does not suffer the shortcomings of the prior art.

### SUMMARY

An opaque blow molded article, comprising a first thermoplastic material; a second thermoplastic material, wherein said first thermoplastic material and said second thermoplastic material have a solubility parameter difference from about 0.1 cal^{1/2}cm^{-3/2} to about 20 cal^{1/2}cm^{-3/2}, and a refractive index difference from about 0.1 to about 1.5; and an additive selected from the group consisting of an alcohol, oil, siloxane fluid, water, and a combination thereof.

The different solubility parameters of the two thermoplastic materials render them partially or entirely immiscible. Although the materials will mix together, the lack of miscibility results in phase separation between the two materials. As a consequence, light passing through the article will experience some reflection and refraction as it passes from one material to another. The difference in refractive index between the two thermoplastic materials is sufficient to render the article opaque. The relative quantities of the two thermoplastic materials, and the refractive index difference itself will determine the degree of opacity. Finally, the additive provides for a smoother surface finish, and changes the way in which the two thermoplastic materials interact, leading to an opaque container with an overall glossier look.

The article may contain equal quantities of the two thermoplastic materials. Preferably, however, there is a greater percentage of one of the thermoplastic materials relative to the other, referred to herein as the primary and secondary thermoplastic materials respectively. As the ratio of primary thermoplastic material to secondary thermoplastic material increases, it is thought that domains of the secondary thermoplastic material will form and disperse within the primary thermoplastic material when they are mixed together. In some cases, the additive may become encapsulated in the domains together with the secondary thermoplastic material. In other cases the additive may form its own independent domains within the primary thermoplastic material or, in cases where the solubility parameter of the additive is similar to that of the primary thermoplastic material, the additive may become absorbed in the primary thermoplastic material.

Without being bound by theory, it is thought that the relative quantities of the primary and secondary thermoplastic materials influence how the materials interact with each other and the additive. In this respect, if there are equal quantities of the primary and secondary thermoplastic material, it is thought that the additive will more naturally interact with whichever thermoplastic material it is miscible with, i.e. where there is little to no difference in solubility parameter. For example, polypropylene (PP) and siloxane fluid have relatively comparable solubility parameters and accordingly, where there are equal quantities of PP and another thermoplastic material (with a higher or lower solubility parameter), the siloxane fluid will likely become combined with or absorbed by the PP.

The same is likely to be true where there is significantly more of one of the thermoplastic materials (the primary thermoplastic material) and the additive has a solubility parameter comparable to the primary thermoplastic material. However, where the solubility parameter of the primary thermoplastic material is significantly different compared with the additive, the additive is likely to form domains of its own within the major thermoplastic material, rather than interacting with either thermoplastic material.

In each scenario, there will be an increase in gloss and opacity, however, the amount of gloss will vary.

Interactions between the different components will also vary dependent on the manufacturing process. For example, in one embodiment, the additive may be pre-mixed with the secondary thermoplastic material to first form a masterbatch that is subsequently mixed with the primary thermoplastic material. In this situation, it is thought that the additive will first form domains within the secondary thermoplastic material that will later be transferred to the primary thermoplastic material. Where there is a relatively small difference in solubility parameter between the secondary thermoplastic material and the additive, during formation of the masterbatch, the additive will likely be absorbed by the secondary thermoplastic material. Later, when the primary thermoplastic material is mixed together with the masterbatch, any domains formed are likely to include a mix of secondary thermoplastic material and additive.

In a preferred embodiment, the solubility parameter difference between the secondary thermoplastic material and the additive is less than 0.5 cal^{1/2}cm^{-3/2} and they are mixed together in a masterbatch prior to mixing with the primary thermoplastic material.

The article may be formed of a single layer comprising the first thermoplastic material, second thermoplastic material, additive and any additional components required to achieve the desired look. In an alternative embodiment, the article may be formed of multiple layers, at least one of which comprises the first thermoplastic material, second thermoplastic material and additive. It is expected that where the article is formed of multiple layers, the outermost layer will comprise the features described herein. The other layers may be formed of one or more thermoplastic materials known for use in blow-molding.

### BRIEF DESCRIPTION OF THE DRAWINGS

While the specification concludes with claims, it is believed that the same will be better understood from the following description taken in conjunction with the accompanying drawings in which:

FIG. 1 shows an article of the prior art that is extrusion blow molded using a combination of PET and PP;

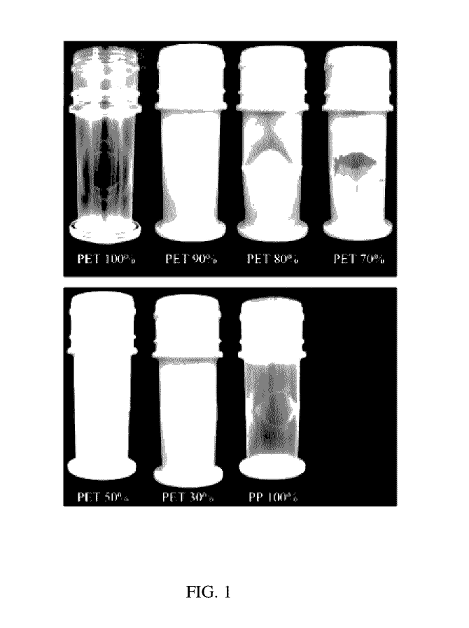

FIGS. 2A, 2B and 2C show schematically one method of obtaining samples using cryogenic fracturing;

FIGS. 3A, 3B and 3C show images at different degrees of magnification generated using scanning electron microscopy of a sample obtained using cryogenic fracturing; and

FIGS. 4A, 4B and 4C show images at different degrees of magnification generated using scanning electron microscopy of a sample obtained using an alternative method of sample preparation.

### DETAILED DESCRIPTION

In the present invention, it has surprisingly been found that blending together two different thermoplastic materials together with an additive such as siloxane fluid can lead to the formation of an article that has a desired opacity and glossiness.

The degree of opacity will depend on a number of factors, for example the manufacturing process, other ingredients included in the blend etc. One key determining factor is the refractive index between the first and second thermoplastic materials mixed together to form the article (or at least one layer of the article). The present inventors have found that the inclusion of an additive ensures that the opaque article also maintains a degree of glossiness, not typically achievable in existing opaque articles.

All percentages are weight percentages based on the weight of the composition, unless otherwise specified. All ratios are weight ratios, unless specifically stated otherwise. All numeric ranges are inclusive of narrower ranges; delineated upper and lower range limits are interchangeable to create further ranges not explicitly delineated. The number of significant digits conveys neither limitation on the indicated amounts nor on the accuracy of the measurements. All measurements are understood to be made at about 25° C. and at ambient conditions, where “ambient conditions” means conditions under about one atmosphere of pressure and at about 50% relative humidity.

“Article”, as used herein refers to an individual blow molded object for consumer usage, eg., a shaver, a toothbrush, a battery, or a container suitable for containing compositions. Preferably the article is a container, non-limiting examples of which include a bottle, a tottle, a jar, a cup, a cap, and the like. The term “container” is used to broadly include elements of a container, such as a closure or dispenser of a container. The compositions contained in such a container may be any of a variety of compositions including, but not limited to, detergents (e.g., laundry detergent, fabric softener, dish care, skin and hair care), beverages, powders, paper (e.g. tissues, wipes), beauty care compositions (e.g., cosmetics, lotions), medicinal, oral care (e.g., tooth paste, mouth wash), and the like. The container may be used to store, transport, or dispense compositions contained therein. Non-limiting volumes containable within the container are from 10 ml, 100 ml, 500 ml or 1000 ml to 1500 ml, 2000 ml or 4000 ml.

“Blow molding” refers to a manufacturing process by which hollow cavity-containing plastic articles are formed. The blow molding process begins with melting or at least partially melting or heat-softening (plasticating) the thermoplastic and forming it into a parison or preform, where said parison or preform can be formed by a molding or shaping step such as by extrusion through a die head or injection molding. The parison or preform is a tube-like piece of plastic with a hole in one end through which compressed gas can pass. The parison or preform is clamped into a mold and air is pumped into it, sometimes coupled with mechanical stretching of the parison or preform (known as “stretch blow-molding”). The parison or preform may be preheated before air is pumped into it. The air pressure pushes the thermoplastic out to conform to the shape of the mold containing it. Once the plastic has cooled and stiffened, the mold opens up and the part is ejected. In general, there are three main types of blow molding: extrusion blow molding (EBM), injection blow molding (IBM), and injection stretch blow molding (ISBM).

“Solubility Paramater (δ/SP)”, as used herein, provides a numerical value representing the degree of interaction between materials. A solubility parameter difference between materials indicates miscibility of the materials. For example, materials with similar δ values are likely to be miscible, and materials having a larger δ difference tend to be more immiscible. The Hildebrand Solubility Parameter is used herein for purposes to characterize a material's δ. The calculation method of the Hildebrand δ and the δ data of certain example materials are described below.

“Refractive Index (RI)”, as used herein, means a ratio of the speed of light in a vacuum relative to that in another medium. RI (nD25) data is used herein, where nD25 refers to the RI tested at 25° C. and D refers to the D line of the sodium light. The calculation method of the RI (nD25) and the RI (nD25) data of certain example materials are described below.

“Domain” as used herein refers to an enclosed area formed within a larger area of thermoplastic material. The domain may be filled with another thermoplastic material that is partially miscible or immiscible with the larger thermoplastic material and/or an additive that is also immiscible or partially miscible with the larger thermoplastic material. Alternatively or additionally, the domain may further have fluid, air or some other gas trapped within. Domains are formed at the time of mixing different materials together. The distribution of domains will depend on a number of factors, including the relative viscosity of the different materials and the speed of mixing the different materials. When first making a preform, any domains formed are likely to be substantially spherical or tubular in shape. Once blow-molded, these substantially spherical or tubular domains take on a more elongate form. If the article is formed by stretch blow-molding, the resultant domains in the final article will likely have a ribbon-like form, forming elongate strands in the direction the article is most stretched.

“Pearlescent agent” as used herein refers to a chemical compound or a combination of chemical compounds of which the principle intended function is to deliver a pearlescent effect to a packaging container or a composition.

“Processing temperature” as used herein refers to the temperature of the mold cavity during the blow step of a blow molding process. During the blow step, the temperature of the material will eventually approach the temperature of the mold cavity, i.e., the processing temperature. The processing temperature is typically higher than the melting point of the material. Different thermoplastic materials typically require different processing temperatures, depending on factors including: melting point of the material, blow molding type, etc. The processing temperature is much higher than the mold temperature which is typically from about 10 to 30° C. Thus, when the material is expanded by air pressure against the surface of the mold, the material is cooled by the mold and finally achieves a temperature equal to or slightly higher than the mold temperature.

“Substantially free’ of a specific ingredient means that the composition comprises less than a trace amount, alternatively less than 0.1%, alternatively less than 0.01%, alternatively less than 0.001%, by weight of the composition of the specific ingredient.

“Liquid” includes gel matrices, liquid crystals, etc. Liquids may be Newtonian or non-Newtonian, and may exhibit a yield point, but flow under sufficient shear stress under standard temperature and pressure conditions.

### Article

The article of the present invention preferably has an opacity value of at least 70%, 80%, 90% or 95% and a Glossiness Value of from about 70, 75, 80 to 90, 100, 110, according to the respective test methods for opacity and glossiness described hereinafter. The article described herein comprises a mix of at least two different thermoplastic materials having a solubility parameter difference of from 0.1 cal^{1/2}cm^{-3/2}, 0.3 cal^{1/2}cm^{-3/2}, 1 cal^{1/2}cm^{-3/2}, 3 cal^{1/2}cm^{-3/2} or 5 cal^{1/2}cm^{-3/2} to 10 cal^{1/2}cm^{-3/2}, 12.5 cal^{1/2}cm^{-3/2}, 15 cal^{1/2}cm^{-3/2} or 20 cal^{1/2}cm^{-3/2}, and a refractive index difference of from 0.01, 0.03, 0.05 to 0.1, 0.3, 0.5 or 1.0.

Where there is a solubility parameter difference of greater than 0.1 cal^{1/2}cm^{-3/2}, the two thermoplastic materials will be at least partially, if not entirely, immiscible. When the two thermoplastic materials are immiscible, light travelling through adjacent areas of the different thermoplastic materials will appreciate a greater and cleaner difference in refractive index. This provides for a more pronounced visual effect, for example, opacity or gloss.

### Thermoplastic Materials

Combining at least two thermoplastic materials with a solubility parameter difference as described above, together with a refractive index difference of at least 0.01 results in an opaque container. The degree of opacity is determined in part by a combination of the ratio of first thermoplastic material to second thermoplastic material and the refractive index difference and how light is reflected and/or refracted through the article. Articles of the present invention may have equal quantities of the first and second thermoplastic materials. However, in a preferred embodiment, there is a greater percentage of one of the thermoplastic materials, hereinafter known as the primary thermoplastic material, whereas the other thermoplastic material is known as the secondary thermoplastic material. It will be appreciated that other known thermoplastic materials could also be combined to form an article in accordance with the present invention. For example, in one embodiment, a third thermoplastic material may be used to form a masterbatch together with the additive prior to inclusion with the first and second thermoplastic materials.

Where two thermoplastic materials are used, and subject to the presence of additive ingredients and mixing conditions of the respective materials, where there is an imbalance in ratio of the first to second thermoplastic material, there is a greater likelihood that the secondary thermoplastic material will collect within domains formed in the primary thermoplastic material. Without being bound by theory, it is thought that the formation of domains within the primary thermoplastic material generally results in a more even spread of the secondary thermoplastic material which improves the overall benefits of gloss and shine. In one embodiment, the weight ratio of the primary thermoplastic material to the secondary thermoplastic material is from about 99.5:0.1, 90:10; 80:20; 70:30; 60:40; or 51:49. In a preferred embodiment, the weight ratio of primary thermoplastic material to secondary thermoplastic material is from about 98:0.8 (with the remaining weight % being made up by the additive and other ingredients) to about 90:9. In reality, the specific ratio of first thermoplastic material to second thermoplastic material may be based on a number of factors including, but not limited to, cost of the respective materials, recyclability, degree of opacity required, and method of manufacture (some materials are better suited to one form of molding vs others).

The first and second thermoplastic materials can be selected from any suitable thermoplastic material as long as they meet the aforementioned requirements in terms of solubility parameter and refractive index. The solubility parameter and refractive index values of various thermoplastic materials are available in the art, and the values of certain example materials are described below.

The first thermoplastic material may be selected from the group consisting of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBT), acrylonitrile styrene (AS), styrene butadiene copolymer (SBC), and a combination thereof. Preferably the first and primary thermoplastic material is selected from the group consisting of PET, PETG, PEN, PS, and a combination thereof. More preferably, the first and primary thermoplastic material is PET.

The second thermoplastic material may be selected from the group consisting of polypropylene (PP), polyethylene (PE), polymethyl methacrylate (PMMA), polyethyl methacrylate, polybutyl methacrylate, polyhexyl methacrylate, poly 2-ethylhexyl methacrylate, polyoctyl methacrylate, polylactide (PLA), ionomer of poly(ethylene-co-methacrylic acid) (e.g., Surlyn® commercially available from DuPont), cyclic olefin polymer (COP), and a combination thereof. Preferably the second and secondary thermoplastic material is selected from the group consisting of PP, PE, PMMA, PLA, and a combination thereof. More preferably, the second and secondary thermoplastic material is PP.

Recycled thermoplastic materials may also be used, e.g. post-consumer recycled polyethylene terephthalate (PCRPET); post-industrial recycled polyethylene terephthalate (PIR-PET); regrind polyethylene terephthalate.

The thermoplastic materials described herein may be formed by using a combination of monomers derived from renewable resources and monomers derived from non-renewable (e.g., petroleum) resources. For example, the thermoplastic material may comprise polymers made from bio-derived monomers in whole, or comprise polymers partly made from bio-derived monomers and partly made from petroleum-derived monomers.

The thermoplastic material used herein could have relatively narrow weight distribution, e.g., metallocene PE polymerized by using metallocene catalysts. These materials can improve glossiness, and thus in the metallocene thermoplastic material execution, the formed article has further improved glossiness. Metallocene thermoplastic materials can, however, be more expensive than commodity materials. Therefore, in an alternative embodiment, the article is substantially free of the expensive metallocene thermoplastic materials.

In an embodiment comprising more than two thermoplastic materials, the third or subsequent thermoplastic material may preferably be selected from the group consisting of synthetic ethylene butylenes styrene (SEBS), polylactic acid (PLA) and a combination thereof.

In an embodiment having multiple layers, the outer layer may comprise at least the first and second thermoplastic materials described above, and the inner layer may comprise, for example, PET, or another material suitable for blow-molding. Any reference to % weight of the article should be interpreted as % weight of a layer for articles formed of multiple layers.

### Additive

The article comprises from about 0.01%, 0.03%, 0.05% or 0.1% to about 1%, 3%, 6% or 8% by weight of the article or a layer of the article, of an additive. In a preferred embodiment, the article comprises about 0.8% of an additive. The amount of additive present in the article is relatively low to ensure structural integrity and to allow ease and efficiency of recycling.

A wide variety of additives are suitable for use herein. In embodiments, the additive material has a solubility parameter from about 5 cal^{1/2}cm^{-3/2}, 10 cal1/2cm^{-3/2}, 20 cal^{1/2}cm^{-3/2}, 25 cal^{1/2}cm^{-3/2} to about 30 cal^{1/2}cm^{-3/2}, 40 cal^{1/2}cm^{-3/2} or 50 cal^{1/2}cm^{-3/2}, and a refractive index from about 1.0, 1.3 or 1.7 to about 2.0, 2.5 or 3.0. In addition to the parameters of solubility parameter and refractive index, certain additives may be preferred due to other characteristics, including but not limited to state under ambient temperature (namely, liquid or solid or gas), odour characteristic, commercial availability, cost, etc.

Where there is a greater percentage of the primary thermoplastic material relative to the secondary thermoplastic material, the solubility parameter difference between the secondary thermoplastic material and the additive is preferably less than 0.5 cal^{1/2}cm^{-3/2}. This provides a certain degree of miscibility between the additive and the secondary thermoplastic material.

Preferably, the additive is selected from the group consisting of an alcohol, oil, siloxane fluid, water, and a combination thereof.

In one embodiment, the additive is an alcohol preferably selected from the group consisting of a diol, triol, and a combination thereof. More preferably, the alcohol is selected from the group consisting of ethylene glycol, propylene glycol, glycerol, butanediol, butanetriol, poly(propylene glycol), derivatives thereof, and a combination thereof. Most preferably, the additive is glycerol.

In another embodiment, the additive is an oil selected from the group consisting of a plant oil, an animal oil, a petroleum-derived oil, and a combination thereof. For example, the additive could be an animal oil selected from the group consisting of tallow, lard, and a combination thereof. Preferably the additive is a plant oil selected from sesame oil, soybean oil, peanut oil, olive oil, castor oil, cotton seed oil, palm oil, canola oil, safflower oil, sunflower oil, corn oil, tall oil, rice bran oil, derivative and combinations thereof.

In a further embodiment, the additive is a siloxane fluid and may be a linear or branched polymer or copolymer. For example, the siloxane fluid may be a diorganosiloxane having one or more pendant or terminal groups selected from a group consisting of hydroxyl, vinyl, amine, phenyl, ethyl and mixtures thereof. Other suitable siloxane fluids include polydimethylsiloxane homopolymers, copoloymers consisting essentially of dimethylsiloxane units and methylphenylsiloxane units, copolymers consisting essentially of diphenylsiloxane units and methylphenylsiloxane units. Mixtures of two or more of such siloxane fluid polymers and copolymers may be used, either as part of a masterbatch, or separately added to the blend of first and second thermoplastic materials.

In an embodiment, the additive is siloxane fluid, preferably polydimethylsiloxane

The additive is preferably in liquid form under ambient temperature. Such a liquid additive, on the one hand, enables a more homogeneous blend with the thermoplastic material before the blow molding, and on the other hand, significantly improves the surface smoothness of the container when located on the container's outer surface, versus pearlescent agents that are typically solid.

The additive herein may be either odorous or odorless. In one embodiment, the additive has an odor that matches the perfume of the composition contained in the container, thus attracting users when displayed on shelf or enhancing the perfume performance of the composition when being used. Alternatively, the additive is odorless and therefore does not adversely affect the perfume performance of the composition contained in the article.

The additive preferably has a relatively high flash point, for example a flash point of greater than 100° C., 150° C., 300° C. to about 400° C. or 500° C. Additives having relatively high flash points, particularly higher than the process temperature conditions (e.g., the typical EBM process temperature of 180° C.) are desirable as they allow for a safer manufacturing process.

### Adjunct Ingredient

The article of the present invention may comprise an adjunct ingredient present in an amount of from 0.0001%, 0.001% or 0.01% to about 1%, 5% or 9%, by weight of the article. Non-limiting examples of the adjunct ingredient include titanium dioxide, pearlescent agent, filler, cure agent, anti-statics, lubricant, UV stabilizer, anti-oxidant, anti-block agent, catalyst stabilizer, colourants, nucleating agent, and a combination thereof.

The pearlescent agent herein could be any suitable pearlescent agents, preferably selected from the group consisting of mica, SiO₂, Al₂O₃, glass fiber and a combination thereof. In one embodiment, low amounts of pearlescent agents are used to provide an enhanced glossy effect. For example, the article may comprise less than 0.5%, 0.1%, 0.01% or 0.001% of pearlescent agent by weight of the article. Without the incorporation of pearlescent agents or by minimizing the amount of pearlescent agents, the glossy container of the present invention avoids the negative impact of pearlescent agents on the surface smoothness of a container, and the recycling issue that use of pearlescent agents may cause.

The container may additionally or alternatively comprise a nucleating agent. Specific examples of the nucleating agent include: benzoic acid and derivatives (e.g., sodium benzoate and lithium benzoate), talc and zinc glycerolate, organocarboxylic acid salts, sodium phosphate and metal salts (e.g., aluminium dibenzoate). The addition of the nucleating agent could improve the tensile and impact properties of the container, as well as prevent the migration of the additive in the container. In the present invention, since the amount of additive is relatively low, the article may be substantially free of a nucleating agent, for example having less than 0.1%, 0.01% or 0.001% , by weight of the article, of the nucleating agent.

### Process of Making the Article

One aspect of the present invention is directed to a process for making a glossy article, comprising the step of mixing together a first thermoplastic material, a second thermoplastic material and an additive selected from the group consisting of an alcohol, oil, siloxane fluid, water, and a combination thereof to form a blow mold blend, wherein the first and second thermoplastic materials have a solubility parameter difference from about 0.1 cal^{1/2}cm^{-3/2} to about 20 cal^{1/2}cm^{-3/2}, and a refractive index difference from about 0.1 to about 1.5.

Preferably, the additive is first combined with a carrier (e.g., a thermoplastic material) to form a masterbatch. Typically, the secondary thermoplastic material is used as the carrier material(s). The masterbatch may be formed by: mixing the thermoplastic material and additive under ambient temperature, and then extruding the resultant mixture of thermoplastic material in a twin screw extruder at a temperature of about 260° C. to form pellets. The pellets are then cooled in a water batch at about 20° C. for 0.5 min to form a masterbatch. The twin screw extruder typically has an extruder length/diameter (L/D) of 43 and diameter of 35.6 mm If any adjunct ingredients are required, they may be added at this stage. For example, some pigment may be added to the masterbatch if the article is intended to be coloured. The masterbatch is then physically mixed with the primary thermoplastic material to form a blow mold blend of primary and secondary thermoplastic materials and the additive at room temperature.

In an alternative embodiment, the carrier is a different thermoplastic material and, in some cases, may be the same as the primary thermoplastic material. In this case, the masterbatch would be added to the primary thermoplastic material and the secondary thermoplastic material to form a blend. Preferably, the masterbatch comprises from about 10% to about 30%, by weight of the masterbatch, of the additive.

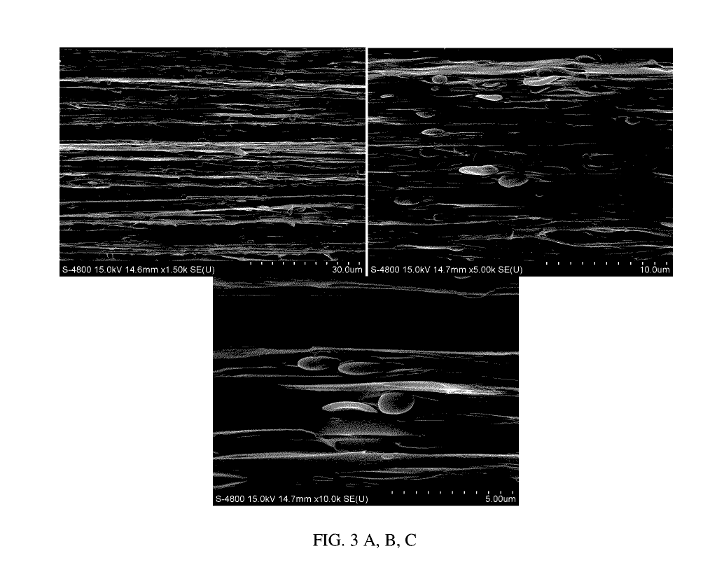

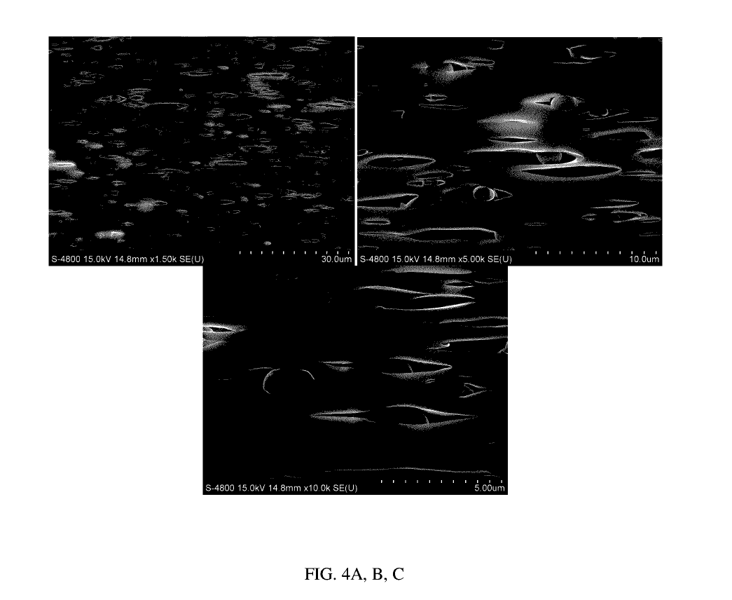

In an embodiment, shown in FIGS. 3 and 4, a masterbatch is prepared comprising 80% (by weight of the masterbatch) of PP and 20% (by weight of the masterbatch) of siloxane fluid. The masterbatch is then added to PET to form a blow mold blend comprising 96% (by weight of the blend) of PET and 4% (by weight of the blend) of the masterbatch (equating to 3.2% PP and 0.8% siloxane fluid).

Alternatively, the additive may be added directly to the thermoplastic material to form a blow mold blend without first forming a masterbatch. In this case, the additive is added directly to the primary thermoplastic material and the secondary thermoplastic material to form a blow-mold blend.

Blowing of the blow mold blend can be conducted by any known blow molding process like extrusion blow molding (EBM), injection blow molding (IBM), or injection stretch blow molding (ISBM). In an ISBM or IBM process, the above blow mold blend is melted and injected into a preform and is followed by a blow molding process or stretch blow molding process. In an EBM process, the above blow molded blend is melted and extruded into a parison and is followed by a blow molding process. The preform or parison is then blown in a mold to form the final article.

In one embodiment, the process herein further comprises the step of cooling the blown article. In the blow molding process, there is typically a sharp drop in the material temperature when the material touches the mold, as the processing temperature of the material is typically higher than the mold temperature. Thus, the material is cooled by the mold and finally achieves a temperature equal to or slightly higher than the mold temperature.

In one embodiment, the present article is a layered container, comprising two or more material layers. For example, the container may have a barrier material layer or a recycled material layer between an outer thermoplastic material layer and an inner thermoplastic material layer. Such layered containers can be made from multiple layer parisons or performs according to common technologies used in the thermoplastic manufacturing field. Within the layered containers, not all of the material layers necessarily comprise the combination of thermoplastic materials and additive of the present invention, but at least one layer should. Where the intention is to provide a superior looking article on shelf, the outermost layer that is visible to a person viewing the shelf, would comprise the features of the invention described herein. Preferably, the outward facing material layer will comprise siloxane fluid as this layer will be visible to a person when viewing a container on a retail store shelf.

### Parameters

Solubility Parameter

The Hildebrand δ is the square root of the cohesive energy density, as calculated by:

$$δ = \sqrt{\frac{Δ {H}_{v} - RT}{{V}_{m}}} \qquad ( 1 )$$

wherein the cohesive energy density is equal to the heat of vaporization (ΔHᵥ) divided by molar volume (Vₘ), R is the gas constant (8.314 J·K⁻¹mol⁻¹), and T is absolute temperature.

The solubility parameter (δ) data of various thermoplastic materials and additives can be calculated by the above method and is readily available from books and/or online databases (e.g., “Handbook of Solubility parameters and Other Cohesion Parameters”, Barton, AFM (1991), 2^{nd} edition, CRC Press, and “Solubility parameters: Theory and Application”, John Burke, The Oakland Museum of California (1984)). The δ values of certain preferred thermoplastic materials and additives are listed in Table 1.

TABLE 1

| Substance | Hildebrand δ (cal^{1/2}cm^{-3/2}) |
|---|---|
| PE | 7.9 |
| PP | 7.6-8.0 |
| PS | 9.11 |
| Ethylene glycol | 16.3 |
| Propylene glycol | 14.8 |
| Glycerol | 21.1 |
| Water | 23.5 |

Refractive Index

The Refractive Index is calculated as:

$$n = \frac{c}{v} \qquad ( 2 )$$

wherein c is the speed of light in vacuum and v is the speed of light in the substance.

The RI (nD25) data of various thermoplastic materials and additives can be calculated by the above method and is readily available from books and/or online RI databases. The RI (nD25) values of certain preferred thermoplastic materials and additives are listed in Table 2.

The below typical RI data is only for illustration purpose, the materials can be customized into different RI.

TABLE 2

| Substance | Refractive index |
|---|---|
| LLDPE | 1.50 |
| PP | 1.40-1.47 |
| PS | 1.589 |
| Ethylene glycol | 1.433 |
| Propylene glycol | 1.388 |
| Glycerol | 1.47 |
| Butanediol | 1.44 |
| Butanetriol | 1.46 |
| Poly(propylene glycol) | 1.447 |
| Sesame oil | 1.46 |
| Soybean oil | 1.46 |
| Peanut oil | 1.466 |
| Olive oil | 1.466 |
| Castor oil | 1.473-1.477 |
| Cotton seed oil | 1.465 |
| Siloxane fluid | 1.36-1.40 |
| Water | 1.333 |

### Test Method

### Scanning Electron Microscopy

### Sample Preparation:

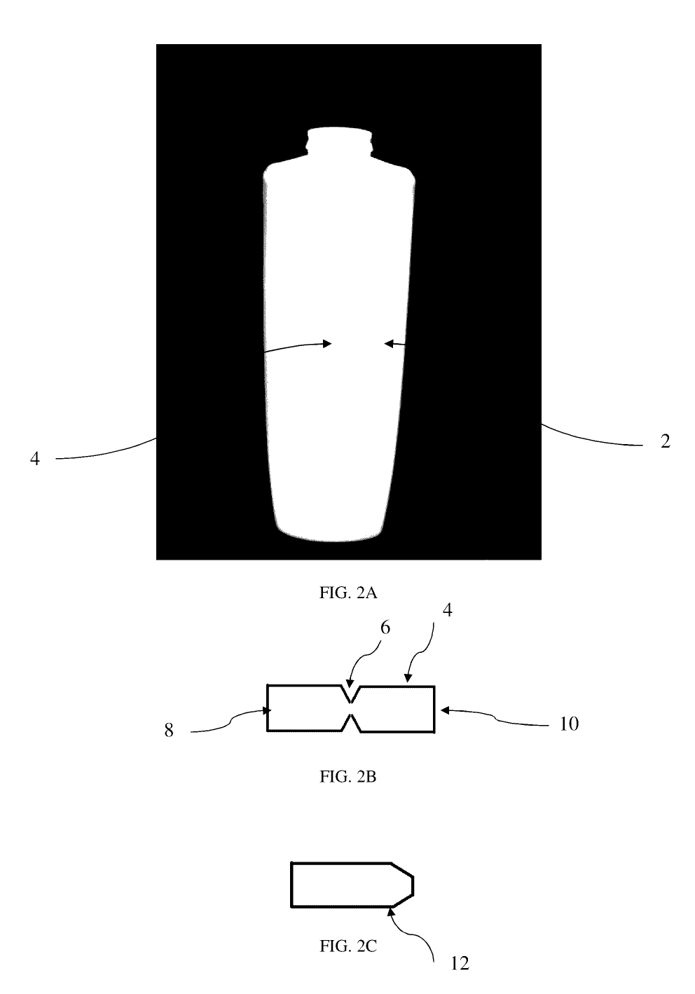

FIG. 2A shows an article of the present invention, displaying in particular the orientation of the article for the purpose of obtaining samples for review using scanning electron microscopy (“SEM”). Two different techniques for obtaining a sample are used and described herein as follows.

### Sample Preparation Method 1

The first sample is prepared using a cryo-fracture process. A rectangular piece 4 of the bottle wall 2 with size around 5 mm×25 mm is cut using scissors. The width of a central section 6 of the rectangular section 4 is reduced to 5 mm×2 mm using a blade as shown in FIG. 2B, to create a shape having a narrow centre and wide outer “wings”, akin to a bow-tie. The bow-tie shaped sample is fully submerged in liquid nitrogen for a minimum of 10 minutes. While the sample is still submerged in the liquid nitrogen, a user grips opposing ends 8, 10 of the sample using two sets of forceps to and rapidly bends the sample. On bending, the sample is fractured/broken at the middle and a cross section of the fractured sample 12 with a thickness of ˜2 to 3 mm×0.5 mm (thickness of bottle wall—shown schematically in FIG. 2C) is observed using a SEM instrument.

### Sample Preparation Method 2

A second sample is cut using a new Teflon coated razor blade (GEM® Stainless Steel Coated, Single Edge Industrial Blades, 62-0165). The blade force is applied parallel to the surface of the bottle, drawing the blade through the section rather than applying force perpendicular to the surface.

Scanning Electron Microscopy images are then taken of all the samples using the following equipment:

Instrument—HITACHI S4800

Coating: Pt, 120 seconds under 15 mA

Work Distance: 15 mm

Accelerate Voltage: 15 kV

### SEM Images

FIGS. 3A-C and FIGS. 4A-C show a series of SEM images of exemplary articles at different degrees of magnification using the different techniques of sample preparation. Using cryo-fraction (Sample Preparation Method 1), as shown in FIGS. 3A, 3B and 3C, the primary thermoplastic material appears to be arranged in lamellar form, with pockets of the secondary thermoplastic and/or additive deposited between layers of the primary thermoplastic material. By contrast, in the samples cut using a blade (Sample Preparation Method 2, shown in FIGS. 4A, 4B and 4C), the primary thermoplastic material appears as a single block with pockets of secondary thermoplastic material and/or additive.

With both techniques, it can be seen that the secondary thermoplastic material and/or additive are deposited within cavities in the first phase of thermoplastic material. The cavities are generally elongate with a larger cross-section through the middle and tapering off at either side. Generally, it seems that pockets or domains of the secondary thermoplastic material are captured at the central, larger point of the cavity and air and/or additive surround them. The exact distribution, structure and shape of the different cavities and domains will depend on a number of factors, including ratio of first phase of thermoplastic material to second phase of thermoplastic material; quantity of additive; speed of introduction of second phase and or additive to the first phase of thermoplastic material (e.g., using a screw); respective viscosities of the different materials, etc.

### Opacity Measure

Opacity is a measure of the capacity of a material to obscure the background behind it.

Opacity measurements are sensitive to material thickness and degree of pigmentation or level of opacifier (e.g. TiO2 particles). The opacity value will be shown as a percentage between 1 and 100%. The value for opacity is obtained by dividing the reflectance obtained with a black backing (RB) for the material, by the reflectance obtained for the same material with a white background (WB). This is called the contrast ratio (CR) method.

$$\% Opacity = \frac{RB}{RW} \times 100$$

### Sample Preparation

A specimen of suitable size (generally about 5 cm square and with a thickness of ˜0.53mm) is cut from the certain position of a bottle. The specimen must be free of creases, wrinkles, tears and other obvious defects.

### Equipment

Opacity for samples CS 1, IS A, IS C, IS D and IS E is measured using the X-Rite Color Spectrometer Model SP64. For all other samples BYK Spectro-Guide 45/0 gloss (6801 Color Spectrophotometer) is used. This opacity value is calculated using the contrast ratio method, in the equipment model of “Opacity”.

### Test Procedure

The specimen is placed on a white tile and inserted into the colorimeter according to the manufacturer's instructions. The machine direction of the specimen should be aligned front-to-back in the instrument. To measure this value, the calibration mode of the spectrometer must include extended measurements for over light and over dark. Samples must then be measured using both a white backing and a dark backing. Firstly, measure the samples over the standard white substrate; the Y reading is recorded to the nearest 0.1 unit. The procedure is repeated using the black standard plate instead of the white standard tile. Finally, measure the sample over the standard white substrate.

5 specimens are measured and the opacity results averaged to obtain the % opacity value for the material.

$$\% Opacity = \frac{{ }^{``} {Y}^{″} on black plate}{{ }^{``} {Y}^{″} on white plate} \times 100$$

The normal standard deviation of measurements taken according to the opacity test is up to 3%.

### Glossiness

An active polarization camera system called SAMBA is used to measure the specular glossiness of the present container. The system is provided by Bossa Nova Technologies and a polarization imaging software named VAS (Visual Appearance Study software, version 3.5) is used for the analysis. The front labeling panel part of the container is tested against an incident light. An exposure time of 15 milliseconds (ms) is used.

The incident light is reflected and scattered by the container. The specular reflected light keeps the same polarization as the incident light and the volume scattered light becomes un-polarized. SAMBA acquires the polarization state of a parallel image intensity (P) contributed by both the reflected and scattered light, and a crossed image intensity (C) of the image contributed only by the scattered light. This allows the calculation of glossiness G given by G=P−C.

In embodiments, the specular glossiness as measured in this test method is greater than 100, preferably greater than 110, 120 or 130.

### EXAMPLES

The Examples herein are meant to exemplify the present invention but are not used to limit or otherwise define the scope of the present invention.

In all comparative and inventive samples, the primary thermoplastic material is PET. In some comparative and all inventive samples, the secondary thermoplastic material is PP and the additives comprise one or more of silicone and titanium dioxide. The combined total % of the resin+additives is 100%.

| | | | Wall | | Specula |
|---|---|---|---|---|---|
| | | % additive/bottle or | Thickness | Opacity (%) | Glossiness |
| # | Resin | layer | (mm) | testing data | (±3%) |
| CS 1 | PET | 0.8% Si | 0.530 | 17.32 | 182 |
| CS 2 | PET | 3.0% PP | 0.530 | 75.24 | 95 |
| CS 3 | PET | (2.4-3%) TiO2 + | 0.530 | 96.22 | 78 |
| | | 0.8% Si | | | |
| ISA | PET | 3.0% PP + 0.8% Si | 0.538 | 91.85 | 134 |

Comparative sample (“CS”) 1 shows one example of a prior art container formed of a single thermoplastic material (PET) with 0.8% of additive (siloxane fluid). CS 1 is not opaque but has high levels of glossiness. CS 2 shows an example of a different prior art container formed of two thermoplastic materials, but no additive—PET as the primary thermoplastic and PP as the secondary thermoplastic. It can be seen here that the container is opaque, but the glossiness level is low (i.e., less than 100). CS 3 includes PET as the primary thermoplastic, and siloxane fluid and titanium dioxide as additives. From this it can be seen that the inclusion of titanium dioxide increases the opacity to an acceptable level, but causes a significant decrease in the level of glossiness, to an unacceptable level. Inventive sample (“IS”) A, is a container formed in accordance with the present invention having PET as the primary thermoplastic material, PP as the secondary thermoplastic material and siloxane fluid added as part of a masterbatch together with the PP. Here it can be seen that, in contrast to the prior art, the container is opaque (opacity level above 70) and it has a high glossiness level (above 100).

| | | | | Opacity | |
|---|---|---|---|---|---|
| | | | Wall | (%) | Specula |
| Sample | | % additive/bottle or | Thickness | testing | Glossiness |
| # | Resin | layer | (mm) | data | (±3%) |
| CS 1 | PET | 0.0% PP + 0.8% Si | 0.530 | 17.32 | 182 |
| IS B | PET | 0.1% PP + 0.8% Si | 0.528 | 24.24 | 184 |
| IS C | PET | 0.5% PP + 0.8% Si | 0.539 | 52.24 | 140 |
| IS D | PET | 1.5% PP + 0.8% Si | 0.522 | 81.33 | 121 |
| IS E | PET | 5.0% PP + 0.8% Si | 0.528 | 99.23 | 111 |
| IS F | PET | 10.0% PP + 0.8% Si | 0.534 | 97.97 | 90 |

Inventive samples B to F are containers of the present invention with PET as the primary thermoplastic material, and a masterbatch of PP and siloxane fluid, with varying quantities of PP. From this table it can be seen that as the amount of PP is increased, the opacity increases, but the glossiness decreases.

| | | | Wall | | Specula |
|---|---|---|---|---|---|
| | | % additive/bottle or | Thickness | Opacity (%) | Glossiness |
| # | Resin | layer | (mm) | testing data | (±3%) |
| IS G | PET | 0.8% PP + 0.1% Si | 0.531 | 68.09 | 133 |
| IS H | PET | 0.8% PP + 0.8% Si | 0.533 | 70.73 | 111 |
| IS I | PET | 0.8% PP + 1.2% Si | 0.535 | 75.43 | 140 |
| IS J | PET | 0.8% PP + 2.0% Si | 0.534 | 78.96 | 146 |

Inventive samples G to J are containers of the present invention with PET as the primary thermoplastic material, and a masterbatch of PP and siloxane fluid, with varying quantities of siloxane fluid. From this table it can be seen that as the amount of siloxane fluid increases, the opacity and glossiness increases. For manufacturing purposes and structural integrity of the container, there is a limit to the amount of siloxane fluid that can reasonably be added.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An opaque molded article, comprising:
a) a first thermoplastic material;
b) a second thermoplastic material, wherein said first thermoplastic material and said second thermoplastic material have a solubility parameter difference from about 0.1 cal^{1/2}cm^{-3/2} to about 20 cal^{1/2}cm^{-3/2}, and a refractive index difference from about 0.1 to about 1.5; and
c) an additive selected from the group consisting of an alcohol, oil, siloxane fluid, water, and a combination thereof.

2. An opaque molded article as claimed in claim 1, wherein one of the first thermoplastic material and the second thermoplastic material is a primary thermoplastic material and the other a secondary thermoplastic material, wherein the primary thermoplastic material accounts for at least 51% of the total weight of the first and second thermoplastic materials combined.

3. An opaque molded article, as claimed in claim 2, wherein the secondary thermoplastic material has a lower refractive index than the primary thermoplastic material.

4. An opaque molded article as claimed in claim 2, wherein the additive has a refractive index difference from about 0.01 to about 1.5 relative to the secondary thermoplastic material .

5. An opaque molded article as claimed in claim 2, wherein the secondary thermoplastic material has a lower solubility parameter than the primary thermoplastic material.

6. An opaque molded article as claimed in claim 2, wherein the additive has a solubility parameter difference of less than 0.5 cal^{1/2}cm^{-3/2} relative to the secondary thermoplastic material.

7. An opaque molded article as claimed in claim 1, wherein said first thermoplastic material is selected from the group consisting of polyethylene terephthalate (PET), polyethylene terephthalate glycol (PETG), polystyrene (PS), polycarbonate(PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBT), acrylonitrile styrene (AS), styrene butadiene copolymer (SBC), and a combination thereof.

8. An opaque molded article as claimed in claim 1, wherein the second thermoplastic material is selected from the group consisting of polypropylene (PP), polyethylene (PE), polymethyl methacrylate (PMMA), polyethyl methacrylate, polybutyl methacrylate, polyhexyl methacrylate, poly 2-ethylhexyl methacrylate, polyoctyl methacrylate, polylactide (PLA), ionomer of poly(ethylene-co-methacrylic acid), cyclic olefin polymer (COP), and a combination thereof.

9. An opaque molded article as claimed in claim 2, wherein the primary thermoplastic material is PET and the secondary thermoplastic material is PP, and there is a percentage of from about 0.1% to about 10% of PP, by weight of the article.

10. An opaque molded article as claimed in claim 1, wherein the additive is present in amount of from about 0.1% to about 8% , by weight of the article.

11. An opaque molded article as claimed in claim 2, wherein the secondary thermoplastic material and additive are mixed together to form a masterbatch prior to combination with the primary thermoplastic material.

12. An opaque molded article as claimed in claim 1, comprising at least an inner layer and an outer layer, wherein the outer layer comprises the first thermoplastic material, the second thermoplastic material and the additive.

13. An opaque molded article as claimed in claim 1, wherein said first thermoplastic material and said second thermoplastic material have a refractive index difference of about 1.0.

14. An opaque molded article as claimed in claim 1, wherein said first thermoplastic material and said second thermoplastic material have a refractive index difference of about 0.5.

15. An opaque molded article as claimed in claim 1, wherein said first thermoplastic material and said second thermoplastic material have a refractive index difference of about 0.3.

16. An opaque molded article as claimed in claim 1, wherein said first thermoplastic material and said second thermoplastic material have a refractive index difference of about 0.1.

17. An opaque molded article as claimed in claim 1, wherein said first thermoplastic material and said second thermoplastic material have a solubility parameter difference from about 0.1 cal^{1/2}cm^{-3/2} to about 20 cal^{1/2}cm^{-3/2}.

18. An opaque molded article as claimed in claim 1, wherein said first thermoplastic material and said second thermoplastic material have a solubility parameter difference from about 1 cal^{1/2}cm^{-3/2} to about 15 cal^{1/2}cm^{-3/2}.

19. An opaque molded article as claimed in claim 1, wherein said first thermoplastic material and said second thermoplastic material have a solubility parameter difference from about 3 cal^{1/2}cm^{-3/2} to about 12.5 cal^{1/2}cm^{-3/2}.

20. An opaque molded article as claimed in claim 1, wherein said first thermoplastic material and said second thermoplastic material have a solubility parameter difference from about 5 cal^{1/2}cm^{-3/2} to about 10 cal^{1/2}cm^{-3/2}.
